(19) United States
(12) Patent Application Publication
(10) Pub. No.: US 2025/0270139 A1
(43) Pub. Date: Aug. 28, 2025

(54) IN-SITU SYNERGISTICALLY MODIFIED AND REINFORCED CEMENT-BASED COMPOSITE MATERIAL AND USE THEREOF

(71) Applicant: Qingdao University of Technology, Qingdao, Shandong (CN)

(72) Inventors: Bing YIN, Qingdao, Shandong (CN); Xianle HUA, Qingdao, Shandong (CN); Dongshuai HOU, Qingdao, Shandong (CN); Dongmei QI, Qingdao, Shandong (CN); Xujiang HUA, Qingdao, Shandong (CN); Pan WANG, Qingdao, Shandong (CN); Shaochun LI, Qingdao, Shandong (CN); Zuquan JIN, Qingdao, Shandong (CN)

(21) Appl. No.: 18/271,000

(22) PCT Filed: Apr. 2, 2022
(86) PCT No.: PCT/CN2022/084964

§ 371 Date: Sep. 9, 2024

(30) Foreign Application Priority Data
Mar. 2, 2022 (CN) 202210197316.9

(51) Int. Cl. C04B 24/26; C04B 14/38; C04B 22/14; C04B 40/00; C04B 40/02; C04B 103/00; C04B 111/50

(52) U.S. Cl. CPC C04B 24/2652; C04B 14/383; C04B 22/14; C04B 40/0046; C04B 40/0281; C04B 2103/0046; C04B 2103/0062; C04B 2111/50

(57) ABSTRACT

The disclosure belongs to the technical field of building materials, and in particular relates to an in-situ synergistically modified and reinforced cement-based composite material and use thereof. The in-situ synergistically modified and reinforced cement-based composite material includes a cementitious material, a polymer monomer, an initiator, a cross-linking agent and a whisker, wherein functional groups of the polymer monomer include a carbon-carbon double bond and a carboxyl group, and the whisker includes at least one selected from the group consisting of an organic whisker and an inorganic non-metallic whisker. The surface modification and adsorption binding of the whisker by the in-situ polymerization of the polymer monomer could improve the dispersibility and binding property of the whisker in the cement matrix, thereby adequately exerting the densification and reinforcement effect of the whisker on cement matrix. Moreover, the whisker and the polymer network formed by in-situ polymerization of the polymer monomer are interpenetratingly bonded, which combines the stiffness and dimensional stability of the whisker with the flexibility and toughness of the polymer macromolecule material, thereby enhancing the reinforcement effect of in-situ polymerization on the flexural strength of the cement-based material and reducing the adverse effect of in-situ polymerization on the compressive strength of the cement-based composite material.

### CROSS-REFERENCE TO RELATED APPLICATION

This application claims the benefit and priority of Chinese Patent Application No. 202210197316.9, entitled “In-situ synergistically modified and reinforced cement-based composite material and use thereof”, and filed with the China National Intellectual Property Administration on Mar. 2, 2022, the disclosure of which is incorporated by reference herein in its entirety as part of the present application.

### TECHNICAL FIELD

The present disclosure belongs to the technical field of building materials, and in particular relates to an in-situ synergistically modified and reinforced cement-based composite material and use thereof.

### BACKGROUND

Cement-based materials are the most widely used building materials, but they, which belong to porous heterogeneous materials, exhibit low flexural strength. Polymer modification is a method that can increase the flexural strength of cement-based materials.

Polymers can form interlinked, interpenetrating networks with cement hydration products in concrete, which can disperse and transfer stress, and thus prevent or reduce crack propagation. Furthermore, polymers can also improve interface structure and properties between the cementitious material and the aggregate, enhance the adhesion among components, and increase the strength of transition zone, thereby significantly improving the performance of the material. In addition, due to having specific functional groups, some polymers are capable of chemically interacting with cement hydration products or metal ions to form specific bridged linkage, which makes it possible to enhance bonding between materials and improve the properties of concrete. However, conventional polymer-modified concrete has problems of non-uniform polymer distribution, and poor compatibility and bonding property between the polymer and hydration products, resulting in an undesirable toughness (flexural strength) modification effect of polymer on cement-based materials (Z. Sun, Q. Xu, Micromechanical analysis of polyacrylamide-modified concrete for improving strengths, Materials Science and Engineering: A. 490 (2008) 181-192, and R. Wang, J. Li, T. Zhang, L. Czarnecki, Chemical interaction between polymer and cement in polymer-cement concrete, Bulletin of the Polish Academy of Sciences Technical Sciences. 64 (2016) 785-792.).

In-situ polymerization of polymer monomers facilitates uniform distribution of the polymer in the cement-based material, and improves compatibility and bonding. Moreover, the in-situ polymerization of the polymer in cement-based material can fill micropores of the cement-based material, resulting in a theoretically dense material, enhanced toughness, and greatly improved flexural strength. However, in situ-polymerization of polymer monomers inhibits and retards hydration of cement and significantly reduces compressive strength, especially early compressive strength (E. Knapen, D. Van Gemert, Cement hydration and microstructure formation in the presence of water-soluble polymers, Cement and Concrete Research. 39 (2009) 6-13, and X. Kong, S. Emmerling, J. Pakusch, M. Rueckel, J. Nieberle, Retardation effect of styrene-acrylate copolymer latexes on cement hydration, Cement and Concrete Research. 75 (2015) 23-41.). Therefore, in-situ polymerization of polymer monomers alone can not improve the toughness (flexural strength) and compressive strength of cement-based composites simultaneously, and the comprehensive performance limits the widespread use of the materials.

### SUMMARY

In view of foregoing, an object of the present disclosure is to provide an in-situ synergistically modified and reinforced cement-based composite material having excellent flexural strength and good compressive strength.

In order to achieve the above object, the present disclosure provides the following technical solutions.

The present disclosure provides an in-situ synergistically modified and reinforced cement-based composite material, comprising a cementitious material, a polymer monomer, an initiator, a cross-linking agent and a whisker, wherein
functional groups of the polymer monomer comprise a carbon-carbon double bond and a carboxyl group; and
the whisker comprises at least one selected from the group consisting of an organic whisker and an inorganic non-metallic whisker.

In some embodiments, the carboxyl is replaced with a group that is hydrolysable into a carboxyl group.

In some embodiments, the polymer monomer comprises at least one selected from the group consisting of an acrylamide monomer, an acrylic polymer monomer, a butyl methacrylate monomer, an ethylene dimethacrylate monomer and a hydroxyethyl methacrylate monomer.

In some embodiment, a mass ratio of the cementitious material to the polymer monomer is in a range of 100: (0.1-10); and the in-situ synergistically modified and reinforced cement-based composite material has a whisker content of 0.5-10 vol. %.

In some embodiment, the organic whisker comprises at least one selected from the group consisting of a cellulose whisker, a chitin whisker, a polybutylacrylate-styrene whisker and a poly(4-hydroxybenzoate) whisker; and the inorganic non-metal whisker comprises at least one selected from the group consisting of a carbide whisker, an oxide whisker, a nitride whisker, a halide whisker, a graphite whisker, and an inorganic salt whisker, the inorganic salt whisker comprising at least one selected from the group consisting of a carbonate whisker, a sulfate whisker, a borate whisker, and a titanate whisker.

In some embodiment, the initiator comprises at least one selected from the group consisting of persulfate, sulfite, an organic peroxide-ferrous salt system, a multi-electron transfer hypervalent compound-sulfite system, and a non-peroxide initiator; and a mass ratio of the polymer monomer to the initiator is in a range of 100: (0.5-5).

In some embodiment, the cross-linking agent has an amino group; and the cross-linking agent is a polyamino cross-linking agent; and

a mass ratio of the polymer monomer to the cross-linking agent is in a range of 100: (0.3-5).

In some embodiment, the cross-linking agent comprises at least one selected from the group consisting of N,N′-methylenebisacrylamide, hexamethylenetetramine/hydroquinone, polyethyleneimine, p-phenylenediamine and dimethylaminoethyl methacrylate.

The present disclosure also provides use of the in-situ synergistically modified and reinforced cement-based composite material according to the above technical solutions in building materials.

In some embodiment, the use comprises the following steps:
mixing the polymer monomer, the initiator, the cross-linking agent and water to obtain an in-situ polymerization solution;
mixing the cementitious material and the whisker to obtain a cementitious material-whisker dry material; and
mixing the cementitious material-whisker dry material and the in-situ polymerization solution to obtain an in-situ synergistically modified and reinforced cement-based composite slurry, and pouring and curing the in-situ synergistically modified and reinforced cement-based composite slurry.

The present disclosure provides an in-situ synergistically modified and reinforced cement-based composite material, comprising a cementitious material, a polymer monomer, an initiator, a cross-linking agent and a whisker, wherein functional groups of the polymer monomer comprises a carbon-carbon double bond and a carboxyl group; and the whisker comprises at least one selected from the group consisting of an organic whisker and an inorganic non-metallic whisker.

In the present disclosure, the in-situ polymerization of the polymer monomer in the presence of the whisker can overcome some drawbacks of the conventional polymer modification to form a uniformly distributed polymer network, which in turn forms a tightly combined organic-inorganic network due to the presence of chemical bonds, thereby being capable of significantly improving the flexural strength of the cement-based material. The whisker can fill in pores between the cement particles, the filling effect of which makes the concrete structure more uniform and dense, and meanwhile, suppresses the generation and propagation of micro-cracks, and this micro-aggregate effect can improve the compressive strength of the concrete. In addition to the reinforcement of cement-based materials by the polymer and whisker described above, there is also a complex synergistic reinforcement effect between in-situ polymerization of the polymer monomer and the whisker. First, the whisker can not only improve the cement-based material, but also reinforce the polymer network generated by the in-situ polymerization of the monomer, which can increase the stability and toughness of the polymer network, and further improve the compressive and flexural resistance of the cement-based composite material. Secondly, the whisker has strong surface energy, readily adsorbing polar groups, and meanwhile, the carboxyl group present in the polymer monomer bonds with the whisker surface ions. Therefore, there are chemisorption by chemically bonding, and physisorption by intermolecular forces and electrostatic forces between the polymer monomer and whisker, making a weak whisker-cementitious material interface or whisker-whisker readily agglomerative interface become a tightly bonded whisker-polymer-cementitious material interface, thus allowing that the whisker binds tightly with the cementitous material and improving whisker agglomeration. In conclusion, the surface modification and adsorption binding of the whisker by the in-situ polymerization of the polymer monomer could improve the dispersibility and binding property of the whisker in the cement matrix, thereby adequately exerting the densification and reinforcement effect of the whisker on cement matrix. Moreover, the whisker and the polymer network formed by in-situ polymerization of the polymer monomer are interpenetratingly bonded, which combines the stiffness and dimensional stability of the whisker with the toughness of the macromolecule material of polymer monomer, thereby enhancing the reinforcement effect of in-situ polymerization on the flexural strength of the cement-based material and reducing the adverse effect of in-situ polymerization on the compressive strength of the cement-based composite material. The in-situ synergistic modification of the polymer monomer with the whisker greatly enhances the comprehensive performance of cement-based materials.

Test results of examples show that the in-situ synergistically modified and reinforced cement-based composite material provided by the present disclosure has a 7-day flexural strength of 6.8-11.3 MPa, a 28-day flexural strength of 7.9-13.2 MPa, a 7-day compressive strength of 38.9-50.5 MPa, and a 28-day compressive strength of 51.2-60.7 MPa, indicating that the composite material has greatly increased flexural strength and meanwhile maintaining high compressive strength, the flexural strength being increased by 40-120% compared with the cement-based material without incorporating the modifying substances (the polymer monomer and the whisker), and the compressive strength reaching 85-98% of the cement-based material without incorporating the modifying substances (the polymer monomer and the whisker).

### BRIEF DESCRIPTION OF THE DRAWINGS

FIG. 1 shows a Scanning Electron Microscopy (SEM) image of the test specimen obtained according to Comparative Example 2.

FIG. 2 shows an SEM image of the test specimen obtained according to Comparative Example 2.

FIG. 3 shows an SEM image of the test specimen obtained according to Example 2.

FIG. 4 shows an SEM image of the test specimen obtained according to Example 2.

FIG. 5 shows an SEM of the test specimen obtained according to Example 5 after soaking in 1 wt. % hydrochloric acid for 60 s.

### DETAILED DESCRIPTION OF THE EMBODIMENTS

The present disclosure provides an in-situ synergistically modified and reinforced cement-based composite material, comprising a cementitious material, a polymer monomer, an initiator, a cross-linking agent and a whisker; wherein
functional groups of the polymer monomer comprise a carbon-carbon double bond and a carboxyl group; and
the whisker comprises at least one selected from the group consisting of an organic whisker and an inorganic non-metallic whisker.

In the present disclosure, unless otherwise specified, each component is commercially available and well known to those skilled in the art.

The in-situ synergistically modified and reinforced cement-based composite material provided by the present disclosure comprises a cementitious material. In some embodiments, the cementitious material comprises a cement. In some embodiments, the cement is an ordinary Portland cement. In some embodiments, a grade of the Portland cement is grade 32.5, grade 42.5 or grade 52.5.

In some embodiments of the present disclosure, the in-situ synergistically modified and reinforced cement-based composite material further comprises at least one selected from the group consisting of an aggregate and an admixture.

In some embodiments, the aggregate comprises at least one selected from the group consisting of sand and gravels. In the present disclosure, there is no special limitation on the sand, and any sand well known to those skilled in the art may be used; there is no special limitation on the gravels, and any gravels well known to those skilled in the art may be used. In some emdobiments, a mass ratio of the cement to the aggregate is in a range of 1: (1-3), and preferably 1: (1.5-2.5).

In some embodiments, the admixture comprises at least one selected from the group consisting of silica fume and fly ash. In some embodiments, a mass ratio of the admixture to the cement is not higher than 1.

The in-situ synergistically modified and reinforced cement-based composite material provided by the present disclosure comprises a polymer monomer. In the present disclosure, the functional groups of the polymer monomer comprise a carbon-carbon double bond and a carboxyl group. As an alternative technical solution of the present disclosure, the functional groups of the polymer monomer comprise a carbon-carbon double bond and a group that is hydrolyzable to a carboxyl group. In some embodiments, the polymer monomer comprises at least one selected from the group consisting of an acrylamide monomer, an acrylic polymer monomer, a butyl methacrylate monomer, an ethylene dimethacrylate monomer, and a hydroxyethyl methacrylate monomer. In some embodiments, the acrylamide monomer comprises at least one selected from the group consisting of acrylamide, hydroxymethylacrylamide and N-isopropylacrylamide.

In some embodiments, a mass ratio of the cementitious material to the polymer monomer is in a range of 100: (0.1-10), preferably 100: (1-7), and more preferably 100: (3-5).

The in-situ synergistically modified and reinforced cement-based composite material provided by the present disclosure comprises an initiator. In some embodiments, the initiator comprises at least one selected from the group consisting of persulfate, sulfite, an organic peroxide-ferrous salt system, a multi-electron transfer hypervalent compound-sulfite system, and a non-peroxide initiator. In some embodiments, the persulfate comprises at least one selected from the group consisting of ammonium persulfate, potassium persulfate and sodium persulfate. In some embodiments, the sulfite comprises at least one selected from the group consisting of sodium sulfite and sodium bisulfite. In some embodiments, the organic peroxide-ferrous salt system comprises tert-butyl hydroperoxide-ferrous sulfate. In some embodiments, the multi-electron transfer hypervalent compound-sulfite system comprises sodium chlorate-sodium sulfite. In some embodiments, the non-peroxide initiator comprises ammonium ceric nitrate-thiourea.

In some embodiments, a mass ratio of the polymer monomer to the initiator is in a range of 100: (0.5-5), preferably 100: (0.8-3), and more preferably 100: (1-2).

The in-situ synergistically modified and reinforced cement-based composite material provided by the present disclosure comprises a cross-linking agent. In some embodiments, the cross-linking agent is a polyamino cross-linking agent. In some embodiments, the cross-linking agent comprises at least one selected from the group consisting of N,N′-methylenebisacrylamide, hexamethylenetetramine/hydroquinone, polyethyleneimine, p-phenylenediamine and dimethylaminoethyl methacrylate.

In some embodiments, a mass ratio of the polymer monomer to the cross-linking agent is in a range of 100: (0.3-5), preferably 100: (0.4-3), and more preferably 100: (0.5-2).

The in-situ synergistically modified and reinforced cement-based composite material provided by the present disclosure comprises a whisker. In the present disclosure, the whisker comprises at least one selected from the group consisting of an organic whisker and an inorganic non-metallic whisker. In some embodiments, the organic whisker comprises at least one selected from the group consisting of cellulose whisker, chitin whisker, polybutylacrylate-styrene whisker and poly(4-hydroxybenzoate) whisker. In some embodiments, the inorganic non-metal whisker comprises at least one selected from the group consisting of a carbide whisker, an oxide whisker, a nitride whisker, a halide whisker, a graphite whisker and an inorganic salt whisker. In some embodiments, the inorganic salt-based whisker comprises at least one selected from the group consisting of a carbonate whisker, a sulfate whisker, a borate whisker and a titanate whisker.

In some embodiments, the in-situ synergistically modified and reinforced cement-based composite material has a whisker content of 0.5-10 vol. %, preferably 0.8-6 vol. %, and more preferably 1-4 vol. %.

The present disclosure also provides use of the in-situ synergistically modified and reinforced cement-based composite material of the above technical solutions in building materials.

In some embodiments, the use comprises the following steps:
mixing the polymer monomer, the initiator, the cross-linking agent and water to obtain an in-situ polymerization solution;
mixing the cementitious material and the whisker to obtain a cementitious material-whisker dry material; and
mixing the cementitious material-whisker dry material and the in-situ polymerization solution to obtain an in-situ synergistically modified and reinforced cement-based composite slurry, and pouring and curing the in-situ synergistically modified and reinforced cement-based composite slurry.

In the present disclosure, the polymer monomer, the initiator, the cross-linking agent and water are mixed to obtain an in-situ polymerization solution.

In some embodiments of the present disclosure, in the use, the in-situ synergistically modified and reinforced cement-based composite slurry is prepared at a preparation temperature of 0 to 50° C., and preferably 0 to 40° C. In the present disclosure, the preparation temperature of the in-situ synergistically modified and reinforced cement-based composite slurry is controlled to prevent premature polymerization of the polymer monomer.

In some embodiments, mixing the polymer monomer, the initiator, the cross-linking agent and water is performed by mixing the polymer monomer and water to obtain a polymer monomer solution, and then mixing the polymer monomer solution, the initiator and the cross-linking agent.

In some embodiments, there is no special limitation on means for mixing the polymer monomer, the initiator, the cross-linking agent and water, and any means well known to those skilled in the art may be used, particularly stirring. In some embodiments, the stirring is magnetic stirring. In some embodiments, the stirring is performed for 5 to 10 min.

In the present disclosure, the cementitious material and the whisker are mixed to obtain a cementitious material-whisker dry material.

In some embodiments, mixing the cementitious material and the whisker is performed by stirring. In some embodiments, the stirring is performed at an autorotation rate of 135 to 145 rpm. In some embodiments, the stirring is performed at a revolution rate of 57 to 67 rpm. In some embodiments, the stirring is performed for 1 to 5 min, and preferably 2 to 3 min.

In some embodiments, under the condition that the in-situ synergistically modified and reinforced cement-based composite material further comprises at least one selected from the group consisting of an aggregate and an admixture, the aggregate and/or admixture are used at a same timing as that of the cementitious material.

In the present disclosure, after obtaining the in-situ polymerization solution and the cementitious material-whisker dry material, the cementitious material-whisker dry material and the in-situ polymerization solution are mixed to obtain an in-situ synergistically modified and reinforced cement-based composite slurry.

In some embodiments, a mass ratio of the cementitious material to water is in a range of 1: (0.35-0.4), preferably 1: (0.37-0.4), and more preferably 1:0.4.

In some embodiments, mixing the cementitious material-whisker dry material and the in-situ polymerization solution is performed by stirring. In some embodiments, the stirring comprises a first stirring and a second stirring. In some embodiments, the first stirring is performed at an autorotation rate of 135 to 145 rpm. In some embodiments, the first stirring is performed at a revolution rate of 57 to 67 rpm. In some embodiments, the first stirring is performed for 1 to 3 min, and preferably 1.5 to 2.5 min. In some embodiments, the second stirring is performed at an autorotation rate of 275 to 295 rpm. In some embodiments, the second stirring is performed at a revolution rate of 115 to 135 rpm. In some embodiments, the second stirring is performed for 60 to 120 s, and preferably 90 to 100 s. In examples of the present disclosure, the mixing is performed with an apparatus of a JJ-5 type cement sand mixer.

In the present disclosure, after obtaining the in-situ synergistically modified and reinforced cement-based composite slurry, the in-situ synergistically modified and reinforced cement-based composite slurry is subjected to pouring and curing.

In the present disclosure, there is no special limitation on the pouring, and the pouring may be performed by any pouring known to those skilled in the art. In specific embodiments, the in-situ synergistically modified and reinforced cement-based composite slurry is sequentially subjected to moulding, shaking, smoothing, covering with a film and demoulding. In some embodiments, the shaking is performed for 60 s. In some embodiments, the film used for the covering is a cling film. In the present disclosure, the covering is performed for 24 h.

In some embodiments, the curing is a standard curing. In some embodiments, the standard curing is performed at a temperature of 18 to 22° C. In some embodiments, the standard curing is performed at a humidity of not lower than 95%.

In order to further illustrate the present disclosure, the in-situ synergistically modified and reinforced cement-based composite material provided by the present disclosure and use thereof are described in detail below with reference to the following examples, which are not to be construed as limiting the scope of the present disclosure. Obviously, the described examples are only some but not all of the examples of the present disclosure. Based on the examples in the present disclosure, all other examples obtained by those of ordinary skill in the art without making creative work, should fall within the scope of the present disclosure.

### Example 1

45 g of acrylamide monomer and 600 g of water were mixed by stirring to obtain a polymer monomer solution. The polymer monomer solution, 0.6 g of ammonium persulfate and 0.3 g of N,N′-methylene bisacrylamide were mixed, and magnetically stirred for 5 min to obtain an in-situ polymerization solution.

1500 g of ordinary Portland cement (P.O grade 42.5) and 31 g of calcium carbonate whisker were mixed by stirring at an autorotation rate of 140 rpm and a revolution rate of 62 rpm for 2 min to obtain a cementitious material-whisker dry material.

The cementitious material-whisker dry material and the in-situ polymerization solution were mixed by stirring at an autorotation rate of 140 rpm and a revolution rate of 62 rpm for 2 min, and then mixed by stirring at an autorotation rate of 285 rpm and a revolution rate of 125 rpm for 90 s to obtain an in-situ synergistically modified and reinforced cement-based composite slurry.

The in-situ synergistically modified and reinforced cement-based composite slurry was moulded, shaken for 60 s, smoothed, covered with a film for 24 h, demoulded, and subjected to a standard curing at a temperature of 18-22° C. and a humidity not lower than 95%.

In this example, in the in-situ synergistically modified and reinforced cement-based composite material, a content of the whisker was 1 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:1.33, and a mass ratio of the polymer monomer (acrylamide monomer) to the cross-linking agent (N,N′-methylene bisacrylamide) was 100:0.67.

### Example 2

Example 2 was performed as Example 1, except that calcium carbonate whisker was used in an amount of 62 g.

In this example, in the in-situ synergistically modified and reinforced cement-based composite material, a content of the whisker was 2 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:1.33, and a mass ratio of the polymer monomer (acrylamide monomer) to the cross-linking agent (N,N′-methylene bisacrylamide) was 100:0.67.

### Example 3

Example 3 was performed as Example 1, except that calcium carbonate whisker was used in an amount of 93 g.

In this example, in the in-situ synergistically modified and reinforced cement-based composite material, a content of the whisker was 3 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:1.33, and a mass ratio of the polymer monomer (acrylamide monomer) to the cross-linking agent (N,N′-methylene bisacrylamide) was 100:0.67.

### Example 4

Example 4 was performed as Example 1, except that calcium carbonate whisker was used in an amount of 124 g.

In this example, in the in-situ synergistically modified and reinforced cement-based composite material, a content of the whisker was 4 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:1.33, and a mass ratio of the polymer monomer (acrylamide monomer) to the cross-linking agent (N,N′-methylene bisacrylamide) was 100:0.67.

### Example 5

Example 5 was performed as Example 1, except that acrylamide monomer was used in an amount of 60 g, ammonium persulfate was used in an amount of 1 g, N,N′-methylene bisacrylamide was used in an amount of 0.5 g, and calcium carbonate whisker was used in an amount of 77.5 g.

In this example, in the in-situ synergistically modified and reinforced cement-based composite material, a content of the whisker was 2.5 vol. %, a mass ratio of the cementitious material (ordinary Portland cement) to the polymer monomer (acrylamide monomer) was 100:4, a mass ratio of the polymer monomer (acrylamide monomer) to the initiator (ammonium persulfate) was 100:1.33, and a mass ratio of the polymer monomer (acrylamide monomer) to the cross-linking agent (N,N′-methylene bisacrylamide) was 100:0.67.

### Example 6

Example 6 was performed as Example 2, except that ammonium persulfate was used in an amount of 0.225 g.

In this example, in the in-situ synergistically modified and reinforced cement-based composite material, a content of the whisker was 1 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:0.5, and a mass ratio of the polymer monomer (acrylamide monomer) to the cross-linking agent (N,N′-methylene bisacrylamide) was 100:0.67.

### Example 7

Example 7 was performed as Example 2, except that ammonium persulfate was used in an amount of 0.45 g.

In this example, in the in-situ synergistically modified and reinforced cement-based composite material, a content of the whisker was 1 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:1, and a mass ratio of the polymer monomer (acrylamide monomer) to the cross-linking agent (N,N′-methylene bisacrylamide) was 100:0.67.

### Example 8

Example 6 was performed as Example 2, except that ammonium persulfate was used in an amount of 0.675 g.

In this example, in the in-situ synergistically modified and reinforced cement-based composite material, a content of the whisker was 1 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:1.5, and a mass ratio of the polymer monomer (acrylamide monomer) to the cross-linking agent (N,N′-methylene bisacrylamide) was 100:0.67.

### Example 9

Example 6 was performed as Example 2, except that ammonium persulfate was used in an amount of 0.9 g.

In this example, in the in-situ synergistically modified and reinforced cement-based composite material, a content of the whisker was 1 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:2, and a mass ratio of the polymer monomer (acrylamide monomer) to the cross-linking agent (N,N′-methylene bisacrylamide) was 100:0.67.

### Example 10

Example 10 was performed as Example 1, except that the acrylamide monomer was replaced with hydroxymethyl acrylamide.

### Example 11

30 g of acrylamide monomer and 400 g of water were mixed by stirring to obtain a polymer monomer solution. The polymer monomer solution, 0.4 g of ammonium persulfate and 0.2 g of N,N′-methylene bisacrylamide were mixed, and magnetically stirred for 5 min to obtain an in-situ polymerization solution.

1000 g of ordinary Portland cement (P.O grade 42.5), 900 g of river sand (with a particle size of 0.075 to 0.6 mm), and 26.8 g of calcium carbonate whisker were mixed by stirring at an autorotation rate of 140 rpm and a revolution rate of 62 rpm for 2 min to obtain a cementitious material-whisker dry material.

The cementitious material-whisker dry material and the in-situ polymerization solution were mixed by stirring at an autorotation rate of 140 rpm and a revolution rate of 62 rpm for 2 min, and then mixed by stirring at an autorotation rate of 285 rpm and a revolution rate of 125 rpm for 90 s to obtain an in-situ synergistically modified and reinforced cement-based composite slurry.

The in-situ synergistically modified and reinforced cement-based composite slurry was moulded, shaken for 60 s, smoothed, covered with a film for 24 h, demoulded, and subjected to a standard curing at a temperature of 18-22° C. and a humidity not lower than 95%.

In this example, in the in-situ synergistically modified and reinforced cement-based composite material, a content of the whisker was 1 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:1.33, and a mass ratio of the polymer monomer (acrylamide monomer) to the cross-linking agent (N,N′-methylene bisacrylamide) was 100:0.67.

### Comparative Example 1

1500 g of ordinary Portland cement (P.O grade 42.5) was added to a mixing kettle, and stirred in a mortar mixer at an autorotation rate of 140 rpm and a revolution rate of 62 rpm for 2 min. 600 g of water was added thereto, and mixed by stirring at an autorotation rate of 140 rpm and a revolution rate of 62 rpm for 2 min, and then mixed by stirring at an autorotation rate of 285 rpm and a revolution rate of 125 rpm for 90 s to obtain a slurry. The slurry was moulded, shaken for 60 s, smoothed and covered with a film for 24 h, demoulded and subjected to a standard curing at a temperature of 18-22° C. and a humidity not lower than 95%.

In this comparative example, no polymer monomer, initiator, cross-linking agent and whisker were used.

### Comparative Example 2

1500 g of ordinary Portland cement (P.O grade 42.5) and 62 g of calcium carbonate whisker were mixed by stirring at an autorotation rate of 140 rpm and a revolution rate of 62 rpm for 2 min to obtain a cementitious material-whisker dry material.

The resulting cementitious material-whisker dry material and 600 g of water were mixed by stirring at an autorotation rate of 140 rpm and a revolution rate of 62 rpm for 2 min, and then mixed by stirring at an autorotation rate of 285 rpm and a revolution rate of 125 rpm for 90 s to obtain a slurry. The slurry was moulded, shaken for 60 s, smoothed and covered with a film for 24 h, demoulded and subjected to a standard curing at a temperature of 18-22° C. and a humidity not lower than 95%.

In this comparative example, no polymer monomer, initiator and cross-linking agent were used, and the content of the whisker in the cement-based composite material was 2 vol. %.

### Comparative Example 3

45 g of acrylamide monomer and 600 g of water were mixed by stirring to obtain a polymer monomer solution. The polymer monomer solution, 0.6 g of ammonium persulfate and 0.3 g of N,N′-methylene bisacrylamide were mixed, and magnetically stirred for 5 min to obtain an in-situ polymerization solution.

1500 g of ordinary Portland cement (P.O grade 42.5) and the in-situ polymerization solution were mixed by stirring at an autorotation rate of 140 rpm and a revolution rate of 62 rpm for 2 min, and then mixed by stirring at an autorotation rate of 285 rpm and a revolution rate of 125 rpm for 90 s to obtain a slurry. The slurry was moulded, shaken for 60 s, smoothed, covered with a film for 24 h, demoulded, and subjected to a standard curing at a temperature of 18-22° C. and a humidity not lower than 95%.

In this comparative example, no whisker was used. In this comparative example, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:1.33, and a mass ratio of the polymer monomer (acrylamide monomer) to the cross-linking agent (N,N′-methylene bisacrylamide) was 100:0.67.

### Comparative Example 4

1500 g of ordinary Portland cement (P.O grade 42.5), and 31 g of calcium carbonate whisker were mixed by stirring at an autorotation rate of 140 rpm and a revolution rate of 62 rpm for 2 min to obtain a cementitious material-whisker dry material.

The cementitious material-whisker dry material and 600 g of water were mixed by stirring at an autorotation rate of 140 rpm and a revolution rate of 62 rpm for 2 min, and then mixed by stirring at an autorotation rate of 285 rpm and a revolution rate of 125 rpm for 90 s to obtain a slurry. The slurry was moulded, shaken for 60 s, smoothed, covered with a film for 24 h, demoulded, and subjected to a standard curing at a temperature of 18-22° C. and a humidity not lower than 95%.

In this comparative example, no polymer monomer, initiator and cross-linking agent were used, and the content of the whisker in the cement-based composite material was 1 vol. %.

### Comparative Example 5

1000 g of ordinary Portland cement (P.O grade 42.5), and 900 g of river sand (with a particle size of 0.075 to 0.6 mm) were added to a mixing kettle, and stirred in a mortar mixer at an autorotation rate of 140 rpm and a revolution rate of 62 rpm for 2 min. 600 g of water was added thereto, and mixed by stirring at an autorotation rate of 140 rpm and a revolution rate of 62 rpm for 2 min, and then mixed by stirring at an autorotation rate of 285 rpm and a revolution rate of 125 rpm for 90 s to obtain a slurry. The slurry was moulded, shaken for 60 s, smoothed, covered with a film for 24 h, demoulded, and subjected to a standard curing at a temperature of 18-22° C. and a humidity not lower than 95%.

In this comparative example, no polymer monomer, initiator, cross-linking agent and whisker were used.

### Comparative Example 6

1500 g of ordinary Portland cement (P.O grade 42.5), 45 g of polyacrylamide polymer and 62 g of calcium carbonate whisker were mixed by stirring at an autorotation rate of 140 rpm and a revolution rate of 62 rpm for 2 min to obtain a dry material.

The dry material was mixed with 600 g of water by stirring at an autorotation rate of 140 rpm and a revolution rate of 62 rpm for 2 min, and then mixed by stirring at an autorotation rate of 285 rpm and a revolution rate of 125 rpm for 90 s to obtain a slurry. The slurry was moulded, shaken for 60 s, smoothed and covered with a film for 24 h, demoulded and subjected to a standard curing at a temperature of 18-22° C. and a humidity not lower than 95%.

In this comparative example, in the cement-based composite material, a content of the whisker was 2 vol. %, a mass ratio of the cementitious material (ordinary Portland cement) to the polymer (polyacrylamide) was 100:3, wherein the polymer was polyacrylamide rather than one obtained by in-situ polymerization of a monomer.

### Comparative Example 7

Comparative example 7 was performed as example 2, except that ammonium persulfate and N,N′-methylene bisacrylamide were not used.

In this comparative example, in the cement-based composite material, a content of the whisker was 2 vol. %, a mass ratio of the cementitious material (ordinary Portland cement) to the polymer monomer (acrylamide monomer) was 100:3, and no initiator and cross-linking agent were used.

### Comparative Example 8

Comparative example 8 was performed as Example 2, except that 144 μL of tetramethylethylenediamine was used as the cross-linking agent to replace N,N′-methylene bisacrylamide.

In this comparative example, in the cement-based composite material, a content of the whisker was 2 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:1.33, and a mass ratio of the polymer monomer (acrylamide monomer) to the cross-linking agent (tetramethylethylenediamine) was 100:0.248.

### Comparative Example 9

Comparative example 9 was performed as Example 2, except that 1.225 g of ammonium persulfate and 1.225 g of sodium sulfite were used as initiators to replace ammonium persulfate mono-initiation system, and N,N′-methylene bisacrylamide was used in an amount of 0.045.

In this comparative example, in the cement-based composite material, a content of the whisker was 2 vol. %, a mass ratio of the cementitious material (ordinary Portland cement) to the polymer monomer (acrylamide monomer) was 100:3, a mass ratio of the polymer monomer (acrylamide monomer) to the initiator (ammonium persulfate) was 100:2.5, a mass ratio of the polymer monomer (acrylamide monomer) to the initiator (sodium sulfite) was 100:2.5, and a mass ratio of the polymer monomer (acrylamide monomer) to the cross-linking agent (N,N′-methylene bisacrylamide) was 100:0.1.

Test specimens obtained according to Examples 1 to 11 and Comparative Examples 1 to 9 were tested for compressive strength and flexural strength according to GB/T 17671-1999 “Method of testing cements-Determination of strength (ISO method)”. The test results are shown in Table 1.

TABLE 1
Test results of compressive strength and flexural
strength of the test specimens obtained according
to Examples 1-11 and Comparative Examples 1-9 (MPa)

| | Flexural strength | | Compressive strength | |
|---|---|---|---|---|
| | 7 days | 28 days | 7 days | 28 days |
| Example 1 | 7.9 | 9.2 | 44.2 | 56 |
| Example 2 | 9.4 | 11.2 | 43.4 | 55.5 |
| Example 3 | 8.7 | 10.2 | 43.3 | 54.6 |
| Example 4 | 8.6 | 9.8 | 42.5 | 53.5 |
| Example 5 | 10.7 | 12.8 | 38.9 | 51.2 |
| Example 6 | 6.8 | 7.9 | 41.4 | 52.6 |
| Example 7 | 8.4 | 9.8 | 43.6 | 53.6 |
| Example 8 | 9.3 | 10.9 | 45.2 | 55.8 |
| Example 9 | 8.7 | 10.3 | 44.8 | 54.2 |
| Example 10 | 8.8 | 10.3 | 47.5 | 58.3 |
| Example 11 | 11.3 | 13.2 | 50.5 | 60.7 |
| Comparative example 1 | 4.9 | 5.8 | 50.4 | 58.9 |
| Comparative example 2 | 5.4 | 6.5 | 55.4 | 67.1 |
| Comparative example 3 | 7.5 | 8.8 | 36.4 | 48.8 |
| Comparative example 4 | 5.5 | 6.6 | 53.5 | 66.2 |
| Comparative example 5 | 5.2 | 6.4 | 56.7 | 65.4 |
| Comparative example 6 | 6.2 | 7.5 | 38.8 | 50.4 |
| Comparative example 7 | 6.9 | 8.1 | 37.6 | 48.2 |
| Comparative example 8 | 7 | 8.3 | 39.7 | 49.8 |
| Comparative example 9 | 7.5 | 8.9 | 39.1 | 48.9 |

As can be seen from Table 1, the in-situ synergistically modified and reinforced cement-based composite material provided by the present disclosure has a 7-day flexural strength of 6.8-11.3 MPa, a 28-day flexural strength of 7.9-13.2 MPa, a 7-daycompressive strength of 38.9-50.5 MPa, and a 28-day compressive strength of 51.2-60.7 MPa, and the flexural strength is increased by 40-120% compared with the cement-based material without modifying substances (Comparative Example 1, Comparative Example 5), and the compressive strength reached 85-98% of the cement-based material without modifying substance (Comparative Example 1, Comparative Example 5).

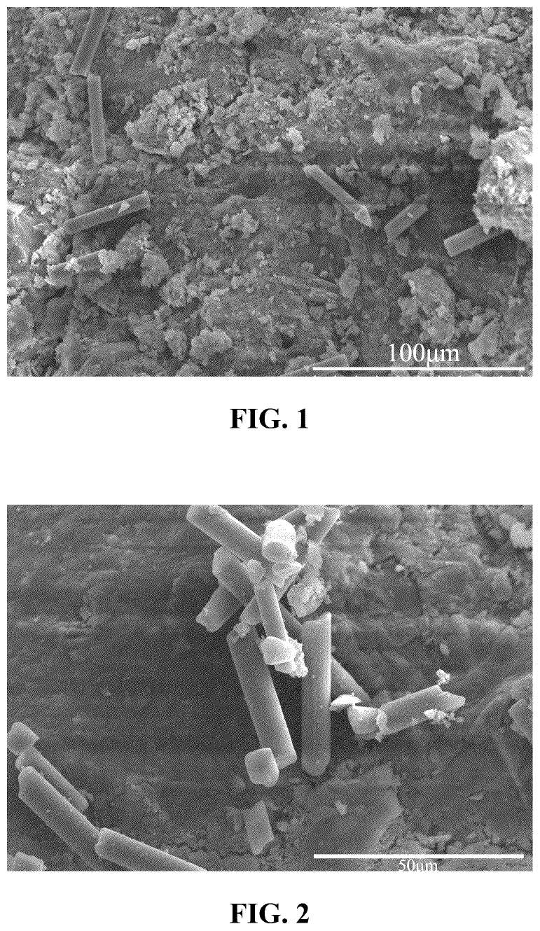

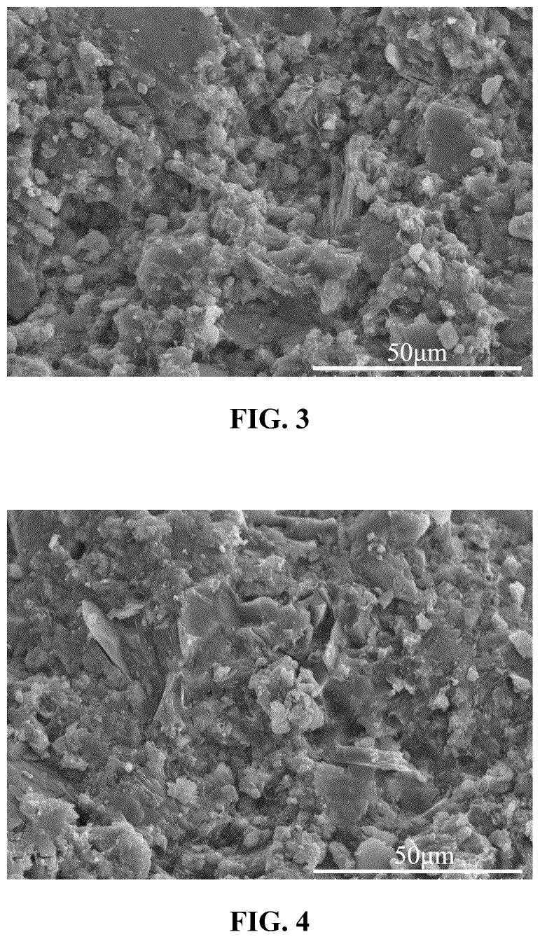

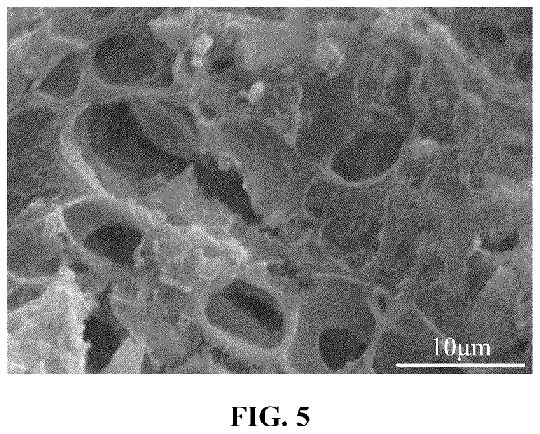

The test samples obtained according to Examples 2, 5 and Comparative Example 2 were subjected to Scanning Electron Microscopy (SEM), and the SEM images obtained are shown in FIGS. 1-5, wherein FIGS. 1 and 2 show SEM images of Comparative Example 2, FIGS. 3 and 4 show SEM images of Example 2, FIG. 5 shows an SEM image of Example 5 (the test specimen obtained according to Example 5 was soaked in 1 wt. % hydrochloric acid for 60 s prior to SEM test).

As can be seen in FIG. 1, when calcium carbonate whisker is used alone to modify, nude calcium carbonate whisker can be observed in section.

As can be seen in FIG. 2, when calcium carbonate whisker is used alone to modify, the calcium carbonate whisker agglomerates.

As can be seen from FIGS. 3 and 4, when the in-situ polymerization of the polymer monomer co-acts with the whisker, the calcium carbonate whisker is integrated with the polymer network and the cement matrix, indicating synergistic reinforcement effect between the calcium carbonate whisker and the in-situ polymerization of the polymer monomer.

It can be seen from FIG. 5 that a clear polymer network structure generated from the in-situ polymerization can be observed, and the presence of calcium carbonate whisker reinforces the polymer network structure.

Although the above embodiments describe the present disclosure in detail, they are only some but not all embodiments of the present disclosure, and one can obtain other embodiments according to the present embodiments without any creative labor, which all shall fall within the scope of the present disclosure.

What is claimed is:

1. An in-situ synergistically modified and reinforced cement-based composite material, comprising a cementitious material, a polymer monomer, an initiator, a cross-linking agent and a whisker;
wherein functional groups of the polymer monomer comprise a carbon-carbon double bond and a carboxyl group; and
the whisker comprises at least one selected from the group consisting of an organic whisker and an inorganic non-metallic whisker.

2. The in-situ synergistically modified and reinforced cement-based composite material of claim 1, wherein the carboxyl group is replaced with a group that is hydrolysable into a carboxyl group.

3. The in-situ synergistically modified and reinforced cement-based composite material of claim 1, wherein the polymer monomer comprises at least one selected from the group consisting of an acrylamide monomer, an acrylic polymer monomer, a butyl methacrylate monomer, an ethylene dimethacrylate monomer and a hydroxyethyl methacrylate monomer.

4. The in-situ synergistically modified and reinforced cement-based composite material of claim 1 or 2, wherein a mass ratio of the cementitious material to the polymer monomer is in a range of 100: (0.1-10), and the in-situ synergistically modified and reinforced cement-based composite material has a whisker content of 0.5-10 vol. %.

5. The in-situ synergistically modified and reinforced cement-based composite material of claim 1, wherein the organic whisker comprises at least one selected from the group consisting of a cellulose whisker, a chitin whisker, a polybutylacrylate-styrene whisker and a poly(4-hydroxybenzoate) whisker; and
the inorganic non-metal whisker comprises at least one selected from the group consisting of a carbide whisker, an oxide whisker, a nitride whisker, a halide whisker, a graphite whisker, and an inorganic salt whisker, the inorganic salt whisker comprising at least one selected from the group consisting of a carbonate whisker, a sulfate whisker, a borate whisker, and a titanate whisker.

6. The in-situ synergistically modified and reinforced cement-based composite material of claim 1, wherein the initiator comprises at least one selected from the group consisting of persulfate, sulfite, an organic peroxide-ferrous salt system, a multi-electron transfer hypervalent compound-sulfite system, and a non-peroxide initiator; and
a mass ratio of the polymer monomer to the initiator is in a range of 100: (0.5-5).

7. The in-situ synergistically modified and reinforced cement-based composite material of claim 1, wherein the cross-linking agent is a polyamino cross-linking agent; and
a mass ratio of the polymer monomer to the cross-linking agent is in a range of 100: (0.3-5).

8. The in-situ synergistically modified and reinforced cement-based composite material of claim 7, wherein the cross-linking agent comprises at least one selected from the group consisting of N,N′-methylenebisacrylamide, hexamethylenetetramine/hydroquinone, polyethyleneimine, p-phenylenediamine and dimethylaminoethyl methacrylate.

9. The in-situ synergistically modified and reinforced cement-based composite material of claim 1, wherein the cementitious material comprises cement.

10. The in-situ synergistically modified and reinforced cement-based composite material of claim 9, wherein the in-situ synergistically modified and reinforced cement-based composite material further comprises at least one selected from the group consisting of an aggregate and an admixture.

11. The in-situ synergistically modified and reinforced cement-based composite material of claim 10, wherein the aggregate comprises at least one selected from the group consisting of sand and gravels, and a mass ratio of the cement to the aggregate is in a range of 1: (1-3).

12. The in-situ synergistically modified and reinforced cement-based composite material of claim 10, wherein the admixture comprises at least one selected from the group consisting of silica fume and fly ash, and a mass ratio of the admixture to the cement is not higher than 1.

13. Use of the in-situ synergistically modified and reinforced cement-based composite material of any one of claims 1 to 12 in building materials.

14. The use of claim 13, wherein the use comprises the following steps:
mixing the polymer monomer, the initiator, the cross-linking agent and water to obtain an in-situ polymerization solution;
mixing the cementitious material and the whisker to obtain a cementitious material-whisker dry material; and
mixing the cementitious material-whisker dry material and the in-situ polymerization solution to obtain an in-situ synergistically modified and reinforced cement-based composite slurry, and casting and curing the in-situ synergistically modified and reinforced cement-based composite slurry.

15. The use of claim 14, wherein a mass ratio of the cementitious material to water is in a range of 1: (0.35-0.4).

16. The use of claim 14, wherein mixing the cementitious material and the whisker is performed by stirring; and
the stirring is performed at an autorotation rate of 135-145 rpm and a revolution rate of 57-67 rpm for 1-5 min.

17. The use of claim 14, wherein mixing the cementitious material-whisker dry material and the in-situ polymerization solution is performed by stirring; and
the stirring comprises a first stirring and a second stirring.

18. The use of claim 17, wherein the first stirring is performed at an autorotation rate of 135-145 rpm and a revolution rate of 57-67 rpm for 1-3 min; and
the second stirring is performed at an autorotation rate of 275-295 rpm and a revolution rate of 115-135 rpm for 60-120 s.

19. The use of claim 14, wherein the curing is performed by a standard curing, the standard curing being performed at a temperature of 18-22° C. and a humidity of not lower than 95%.
